(19) United States
(12) Patent Application Publication
(10) Pub. No.: US 2025/0162232 A1
(43) Pub. Date: May 22, 2025

(54) SYSTEM AND METHOD FOR BLOW MOLDING PLATE COMPONENTS FOR ARTICLES OF FOOTWEAR

(71) Applicant: NIKE, Inc., Beaverton, OR (US)

(72) Inventors: Jeremy D. Walker, Portland, OR (US); James M.F. Webster, Tigard, OR (US)

(73) Assignee: NIKE, Inc., Beaverton, OR (US)

(21) Appl. No.: 18/516,666

(22) Filed: Nov. 21, 2023

(51) Int. Cl. B29C 49/04; B29C 49/22; B29C 49/60; B29K 105/26; B29L 31/50

(52) U.S. Cl. CPC B29C 49/04104; B29C 49/22; B29C 49/60; B29K 2105/26; B29L 2031/504

(57) ABSTRACT

A blow molding system comprising an extrusion system including at least one extruder configured to extrude a parison having an interior cavity, a blow pin configured to extend into the interior cavity of the parison extruded from the extrusion system, and a mold assembly defining a mold chamber configured to receive the parison, the mold assembly including a plurality of mold cavities each facing the mold chamber and defining a profile of a sole component of an article of footwear. A method comprising the blow molding system forms a plurality of sole plates for an article of footwear.

### FIELD

The present disclosure relates generally a system for molding a sole plate for an article of footwear, and more particularly, to a system for simultaneously blow molding a plurality of sole plates for articles of footwear.

### BACKGROUND

This section provides background information related to the present disclosure and is not necessarily prior art.

Articles of footwear conventionally include an upper and a sole structure. The upper may include any suitable material(s) to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

Sole structures generally include a layered arrangement extending between a ground surface and the upper. One layer of the sole structure includes an outsole that provides abrasion-resistance and traction with the ground surface. The outsole may include a sole plate formed of a rigid or semi-rigid material that provides rigidity and energy distribution across the sole structure. The sole plate may be provided with one or more types of traction elements for maximizing engagement with a ground surface. In some cases, the traction elements may be fixed to the outsole plate or integrally molded with the sole plate.

Sole plates are typically manufactured using injection molding processes. While suitable, injection molding processes can be relatively costly due to the complexity of molds and molding materials. Additionally, injection molding processes may limit the types of materials that can be used, as some chemistries of materials are not compatible with each other when combined in an injection molding process.

### DRAWINGS

The drawings described herein are for illustrative purposes only of selected configurations and not all possible implementations, and are not intended to limit the scope of the present disclosure.

FIG. 1 is a schematic view showing a cross section of an example configuration of a blow molding system in accordance with the principles of the present disclosure;

FIG. 2 is a schematic view showing the cross section of the blow molding system of FIG. 1, where a molding material is extruded into a mold as a parison;

FIG. 3 is a schematic view showing the cross section of the blow molding system of FIG. 1, where a mold assembly is moved to a closed configuration;

FIG. 4 is a schematic view showing the cross section of the blow molding system of FIG. 1, wherein the parison is expanded into mold cavities of the mold;

FIG. 5 is a schematic view showing the cross section of the blow molding system of FIG. 1, wherein the mold is opened for removal of a molded article;

FIG. 6 is a perspective view of the molded article of FIG. 5, showing a step of separating molded article sections;

FIG. 7 is a perspective view of the separated molded article sections of FIG. 6;

FIG. 8 is a perspective view of one of the separated molded article sections of FIG. 7, showing a sole plate being removed from the molded article section;

FIG. 9 is a schematic view showing a cross section of an example configuration of a blow molding system in accordance with the principles of the present disclosure;

FIG. 10 is a schematic view showing the cross section of the blow molding system of FIG. 9, where a molding material is extruded into a mold as a parison;

FIG. 11 is a schematic view showing the cross section of the blow molding system of FIG. 9, where a mold assembly is moved to a closed configuration;

FIG. 12 is a schematic view showing the cross section of the blow molding system of FIG. 9, wherein the parison is expanded into mold cavities of the mold;

FIG. 13 is a schematic view showing the cross section of the blow molding system of FIG. 9, wherein the mold is opened for removal of a molded article;

FIG. 14 is a perspective view of the molded article of FIG. 13, showing a step of separating molded article sections;

FIG. 15 is a perspective view of the separated molded article sections of FIG. 14;

FIG. 16 is a perspective view of one of the separated molded article sections of FIG. 15, showing a sole plate being removed from the molded article section;

FIG. 17 is a schematic view showing a cross-section of another example configuration of a blow molding system in accordance with the principles of the present disclosure;

FIG. 18 is a schematic view showing the cross section of the blow molding system of FIG. 17, where a molding material is extruded into a mold as a parison;

FIG. 19A is a cross-sectional view of the blow molding system of FIG. 18, taken along Line 19-19 of FIG. 18 and showing the parison within the mold system;

FIG. 19B is a cross-sectional view of the blow molding system of FIG. 18, taken along Line 19-19 of FIG. 18 and showing the parison expanded within the mold system; and

FIG. 20 is a molded article produced using the blow molding system of FIG. 17.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

An aspect of the disclosure provides a blow molding system. The blow molding system includes an extrusion system including at least one extruder configured to extrude a parison having an interior cavity. The blow molding system also includes a blow pin configured to extend into the interior cavity of the parison extruded from the extrusion system. The blow molding system further includes a mold assembly defining a mold chamber configured to receive the parison. The mold assembly includes a plurality of mold cavities each facing the mold chamber and defining a profile of a sole component of an article of footwear.

Implementations of the disclosure may include one or more of the following optional features. In some examples, at least one extruder includes a first extruder configured to extrude a first layer of the parison and a second extruder configured to extrude a second layer of the parison concentric with the first layer. In some implementations, the first layer includes a first material and the second layer includes a second material different than the first material. In some configurations, the first material and the second material are selected from at least one of a polypropylene, a high-density polyethylene, a thermoplastic polyurethane, or a polyamide. In some further configurations, at least one of the first material and the second material includes a recycled material.

In some examples, the plurality of mold cavities includes a first mold cavity defining a profile of a first sole plate of an article of footwear and a second mold cavity defining a profile of a second sole plate of the article of footwear having a different configuration than the first sole plate. In some implementations, the plurality of mold cavities includes a first plurality of first mold cavities each defining a profile of a first sole plate of an article of footwear and a second plurality of second mold cavities each defining a profile of a second sole plate of the article of footwear having a different configuration than the first sole plate. In some configurations, each of the plurality of the mold cavities defines a profile for a sole plate including a full-length sole plate body and a plurality of traction elements.

In some examples, a sole plate for an article of footwear is formed using the blow molding system of any one of the above examples, configurations, or implementations. In some implementations, an article of footwear that includes the sole plate is formed.

Another aspect of the disclosure provides a method of forming a plurality of sole plates for an article of footwear. The method includes extruding a parison into a mold chamber of a mold assembly. The mold assembly includes a plurality of mold cavities each facing the mold chamber and defining a profile of the sole plate of an article of footwear. The method also includes expanding the parison in the mold chamber, a material forming the parison conforming to the plurality of the mold cavities and forming a molded article including the plurality of the sole plates.

Implementations of this aspect of the disclosure may include one or more of the following optional features. In some examples, extruding the parison includes extruding a first layer of the parison and a second layer of the parison concentric with the first layer. In some implementations, extruding the first layer of the parison and the second layer of the parison includes continuously extruding the first layer and intermittently extruding the second layer along a length of the parison. In some examples, the first layer includes a first material and the second layer includes a second material different than the first material. In some configurations, the first material and the second material are selected from at least one of a polypropylene, a high-density polyethylene, a thermoplastic polyurethane, or a polyamide. In some further configurations, at least one of the first material and the second material comprises a recycled material.

In some examples, the plurality of mold cavities includes a first mold cavity defining a profile of a first sole plate of an article of footwear and a second mold cavity defining a profile of a second sole plate of the article of footwear having a different configuration than the first sole plate. In some implementations, the plurality of mold cavities includes a first plurality of first mold cavities each defining a profile of a first sole plate of an article of footwear and a second plurality of second mold cavities each defining a profile of a second sole plate of the article of footwear having a different configuration than the first sole plate.

In some configurations, each of the mold cavities defines a profile for a sole plate including a full-length sole plate body and a plurality of traction elements. In some examples, the method further includes separating the plurality of the sole plates from the molded article.

The present disclosure provides a system and method for blow molding polymer components for articles of footwear, and particularly, multi-layer sole plates for articles of footwear. Conventionally, sole plates and other polymeric components of footwear are manufactured using injection molding processes, or in some instances, additive manufacturing (e.g., three-dimensional printing). While suitable, these processes can be time and labor intensive. Blow molding is a low-cost and efficient manufacturing method that enables lightweight products to be manufactured that can be mono-layer or multi-layer, thereby enabling unique material combinations to be achieved in a single process. Additionally, molds associated with blow molding systems are typically less expensive relative to molds associated with injection molding processes. As discussed herein, the molds used with blow molding processes may include multiple mold plates for forming a plurality of mold plates simultaneously. Use of extruded materials in a blow molding process also enables the option of incorporating recycled content or foamed layers within the center layers of a sole plate, thereby improving sustainability while maintaining desired aesthetics and performance qualities.

The details of one or more implementations of the disclosure are set forth in the accompanying drawings and the description below. Other aspects, features, and advantages will be apparent from the description, the drawings, and the claims.

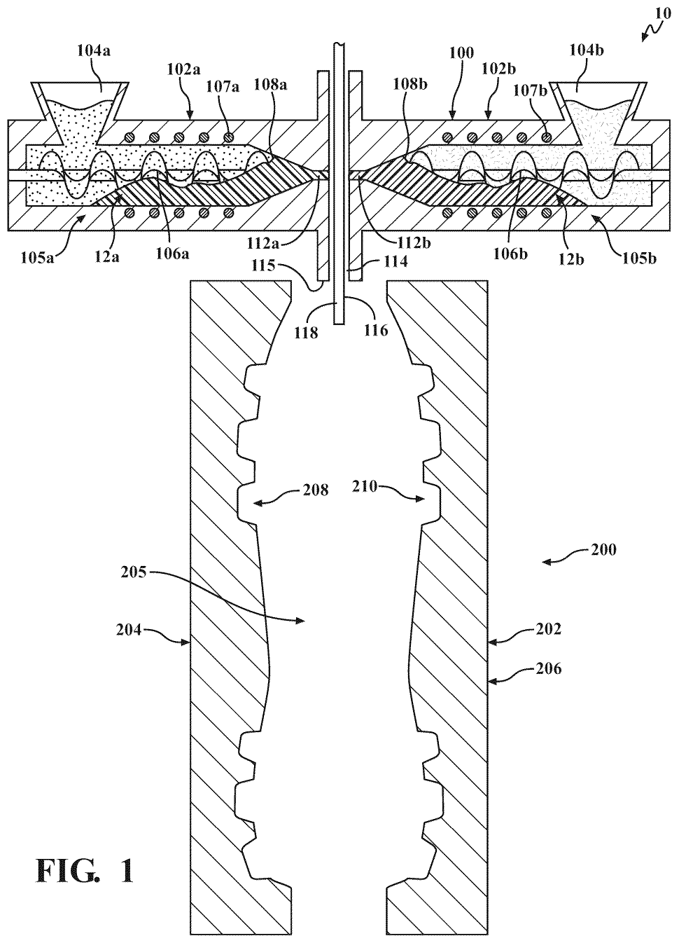

Referring to FIGS. 1-5, a blow molding system 10 is provided according to an example of the present disclosure. The blow molding system 10 includes an extrusion system 100 and a mold system 200 configured to produce a blow-molded article 300 including a plurality of sole plates 306, 308 for use in manufacturing of an article of footwear. Thus, the plurality of the sole plates 306, 308 can be simultaneously formed by the blow molding system 10.

Referring to FIG. 1, the extrusion system 100 includes one or more extruders 102a, 102b, including a first extruder 102a configured to extrude a first mold material 12a and a second extruder 102b configured to extrude a second mold material 12b. While the illustrated example is provided with first and second extruders 102a, 102b for the sake of clarity, it should be appreciated that the extrusion system 100 may include additional extruders as desired. For example, and as discussed below, the extrusion system 100 may include a third extruder including the first material 12a or a third material and configured to extrude a third layer. In this configuration, the second material 12b may be encapsulated or interposed between the two layers of the first material 12a.

The first extruder 102a includes a first hopper 104a for receiving the first mold material 12a in a raw form, such as in a pellet form. The first extruder 102a further includes an extruder barrel 105a including a first extruder screw 106a and a heating element 107a for heating the first mold material 12a to a molten state. The extruder barrel 105a includes a first nozzle 108a disposed at an end of the first extruder screw 106a for receiving the molten first mold material 12a.

The second extruder 102b includes a second hopper 104b for receiving the second mold material 12b in a raw form, such as in a pellet form. The second extruder 102b further includes an extruder barrel 105b including a second extruder screw 106b and a heating element 107b for heating the second mold material 12b to a molten state. The extruder barrel 105b includes a second nozzle 108b disposed at an end of the second extruder screw 106b for receiving the molten second mold material 12b.

Each of the nozzles 108a, 108b of the extruders 102a, 102b may be in communication with a corresponding manifold 112a, 112b, which provide a passageway for the respective mold materials 12a, 12b to an end die 114 of the extrusion system 100. The manifolds 112a, 112b are configured to introduce the mold materials 12a, 12b to the end die 114 in a sequential manner, whereby the first mold material 12a is provided to the end die 114 upstream of the second mold material 12b such that the second mold material 12b is layered upon an outer surface of the first mold material 12a to form layers 16a, 16b of a coextruded parison 14 including both materials 12a, 12b. In other words, the first mold material 12a forms an inner layer 16a of the parison 14 and the second mold material 12b forms an outer layer 16b of the parison 14. While the illustrated example of the extrusion system 100 is configured for coextruding two concentric layers 16a, 16b of mold materials 12a, 12b, it will be appreciated that molding systems having other configurations may be utilized. For example, the extrusion system 100 may be configured to coextrude a parison 14 including three or more tubular layers 16a, 16b. Optionally, the extrusion system 100 may be configured to extrude a parison 14 having a single layer 16a of just the first mold material 12a.

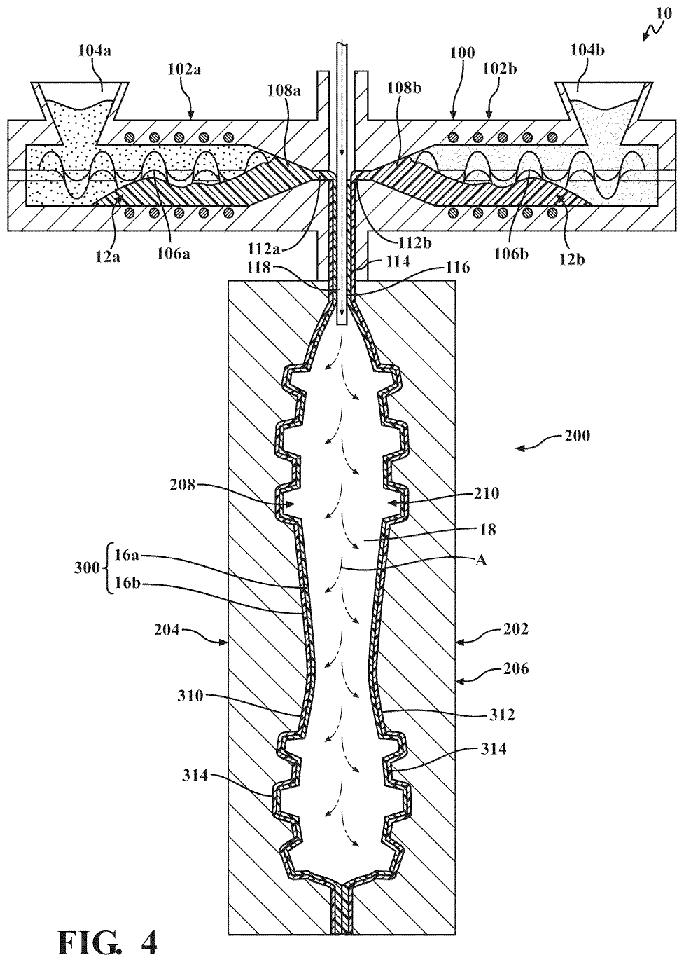

Referring still to FIG. 1, the extrusion system 100 includes a blow pin 116 positioned within the end die 114 and extending from an outlet end 115 of the end die 114. The blow pin 116 is configured to extend within an interior cavity 18 of the parison 14 and into the mold system 200. While the illustrated example shows the layers 16a, 16b of the parison 14 being directly adjacent to the blow pin 116, other extrusion systems 100 may be configured such that the layers 16a, 16b of the parison 16 are spaced radially outwardly from the blow pin 116 and may be separated from the blow pin 116 by a portion of the end die 114 (e.g., an annular spacer). The blow pin 116 is configured to receive a pressurized fluid (e.g., air) and to inject the pressurized fluid into the interior cavity 18 of the parison 14 to expand the parison 14 within the mold assembly 200, as described below with respect to FIG. 4.

As set forth above, the extrusion system 100 is configured to coextrude first and second materials 12a, 12b. While the first and second materials 12a, 12b may be the same, an advantage of the extrusion system 100 is that it allows different materials to be coextruded as unique layers of the parison 14. The layers 16a, 16b of the parison 14 can comprise an elastomeric material that includes one or more thermoplastic polymers and/or one or more cross-linkable polymers. In an aspect, the elastomeric material can include one or more thermoplastic elastomeric materials, such as one or more thermoplastic polyurethane (TPU) copolymers, one or more ethylene-vinyl alcohol (EVOH) copolymers, and the like.

As used herein, “polyurethane” refers to a copolymer (including oligomers) that contains a urethane group (—N(C═O)O—). These polyurethanes can contain additional groups such as ester, ether, urea, allophanate, biuret, carbodiimide, oxazolidinyl, isocynaurate, uretdione, carbonate, and the like, in addition to urethane groups. In an aspect, one or more of the polyurethanes can be produced by polymerizing one or more isocyanates with one or more polyols to produce copolymer chains having (—N(C═O)O—) linkages.

Examples of suitable isocyanates for producing the polyurethane copolymer chains include diisocyanates, such as aromatic diisocyanates, aliphatic diisocyanates, and combinations thereof. Examples of suitable aromatic diisocyanates include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′-dimethyldiphenyl-4, 4′-diisocyanate (DDDI), 4,4′-dibenzyl diisocyanate (DBDI), 4-chloro-1,3-phenylene diisocyanate, and combinations thereof. In some embodiments, the copolymer chains are substantially free of aromatic groups.

In particular aspects, the polyurethane polymer chains are produced from diisocynates including HMDI, TDI, MDI, H12 aliphatics, and combinations thereof. In an aspect, the thermoplastic TPU can include polyester-based TPU, polyether-based TPU, polycaprolactone-based TPU, polycarbonate-based TPU, polysiloxane-based TPU, or combinations thereof.

In another aspect, the polymeric layers can be formed of one or more of the following: EVOH copolymers, poly(vinyl chloride), polyvinylidene polymers and copolymers (e.g., polyvinylidene chloride), polyamides (e.g., amorphous polyamides), amide-based copolymers, acrylonitrile polymers (e.g., acrylonitrile-methyl acrylate copolymers), high-density polyethylene, polyethylene terephthalate, polyether imides, polyacrylic imides, and other polymeric materials. Blends of these materials as well as with the TPU copolymers described herein and optionally including combinations of polyimides and crystalline polymers, are also suitable.

In some examples, where a first material 12a and a second material 12b are selected that are incompatible (e.g., do not naturally bond to each other in a molten state), the extrusion system 100 may include an intermediate extruder configured to extrude an intermediate adhesive material for bonding the first material 12a to the second material 12b. Thus, the parison 14 may comprise two or more layers (multilayer extrusion) joined by an adhesive. Additionally or alternatively, extrusion system 100 may include one or more extruders configured to extrude an adhesive material adjacent to the exposed surfaces of the inner layer 16a and/or the outer layer 16b. For example, an adhesive layer may be extruded and applied to an exposed surface of the inner layer 16a corresponding to a footbed of the sole plate 306, 308, whereby the adhesive enables adhesion of the sole plate 306, 308 to an upper (e.g., to the strobel). Optionally, an adhesive layer may be extruded and applied to an exposed surface of the outer layer 16b corresponding to a ground-engaging surface of the sole plate 306, 308, whereby the adhesive enables adhesion of one or more traction elements to the ground-engaging surface of the sole plate 306, 308. In further configurations, the parison 14 may comprise alternating layers of one or more first copolymer materials and one or more second copolymer materials, where the total number of layers in the parison 14 includes at least four (4) layers, and/or at least ten (10) layers.

In some examples, the first material 12a or the second material 12b may include recycled or upcycled materials, which may be obtained from reclaimed scrap of prior extrusions. Recycled material is understood to be distinguishable from “virgin” materials that have never been utilized in a manufacturing process. In configurations utilizing a recycled or reclaimed material, the parison 14 may be formed with three or more layers 16a, 16b, including inner and outer layers 16a, 16b including virgin first material 12a or second material 12b and an intermediate layer including the recycled second material interposed between the inner and outer layers 16a, 16b. Thus, the parison 14 and the resulting sole plates 306, 308 will include a portion of recycled material concealed between virgin material layers 16a, 16b. Thus, the resulting sole plates 306, 308 provide the benefits of using sustainable materials while maintaining the exterior aesthetics associated with virgin materials.

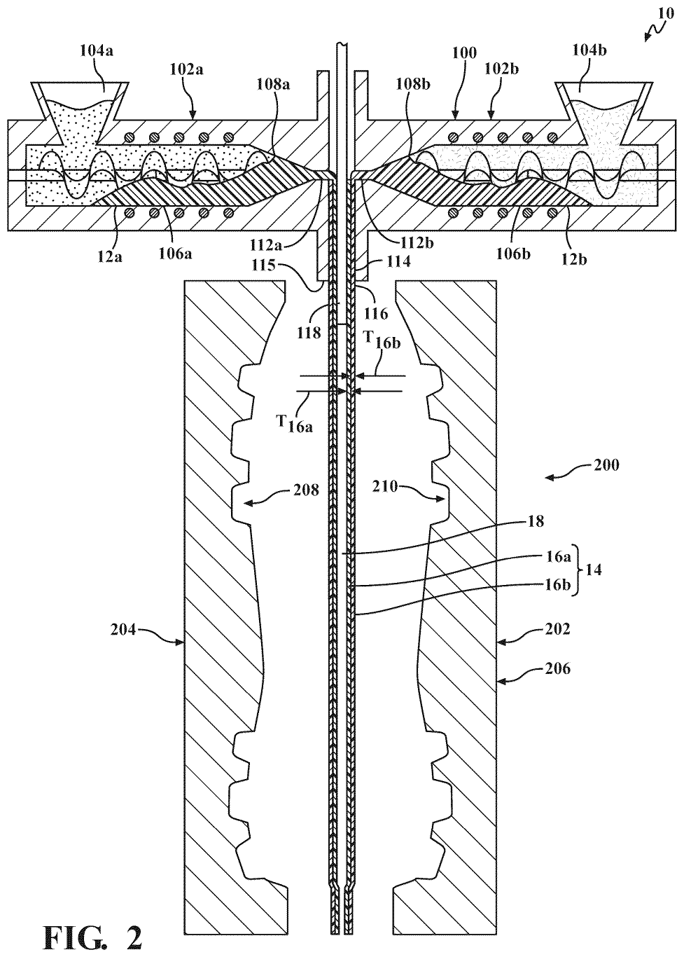

Referring still to FIG. 1, the blow molding system 10 further includes a mold system 200 including a mold assembly 202 operable between an open configuration (FIG. 1) and a closed configuration (FIG. 2). The mold assembly 202 includes a first mold plate 204 and a second mold plate 206, which are configured to interface with each other in the closed configuration to define a mold chamber 205 configured to receive the parison 14. The first mold plate 204 defines a first mold cavity 208 corresponding to the profile of a first sole plate 306 to be molded using the blow molding system 10. The second mold plate 206 defines a second mold cavity 210 corresponding to the profile of a second sole plate 308 to be molded using the blow molding system 10. In the illustrated example, the first mold cavity 208 and the second mold cavity 210 are mirror images of each other, whereby the first mold cavity 208 is configured for molding a first sole plate 306 corresponding to a left-footed article of footwear and the second mold cavity 210 is configured for molding a second sole plate 308 corresponding to a right-footed article of footwear. Thus, the mold assembly 202 is configured to simultaneously mold a pair of the mold plates 204, 206 for a single pair of footwear. In other examples, the mold cavities 208, 210 may have the same configuration (e.g., both left-footed) or may have different profiles (e.g., different sizes, shapes, and/or arrangements of traction elements). Further, while the illustrated example shows mold plates 204, 206 each defining a single mold cavity 208, 210, the mold plates 204, 206 may be configured to include two or more of the mold cavities 208, 210. Further, while the mold cavities 208, 210 of the illustrated example are provided as “female” or negative mold cavities, the mold plates 204, 206 may include “male” or positive mold geometries.

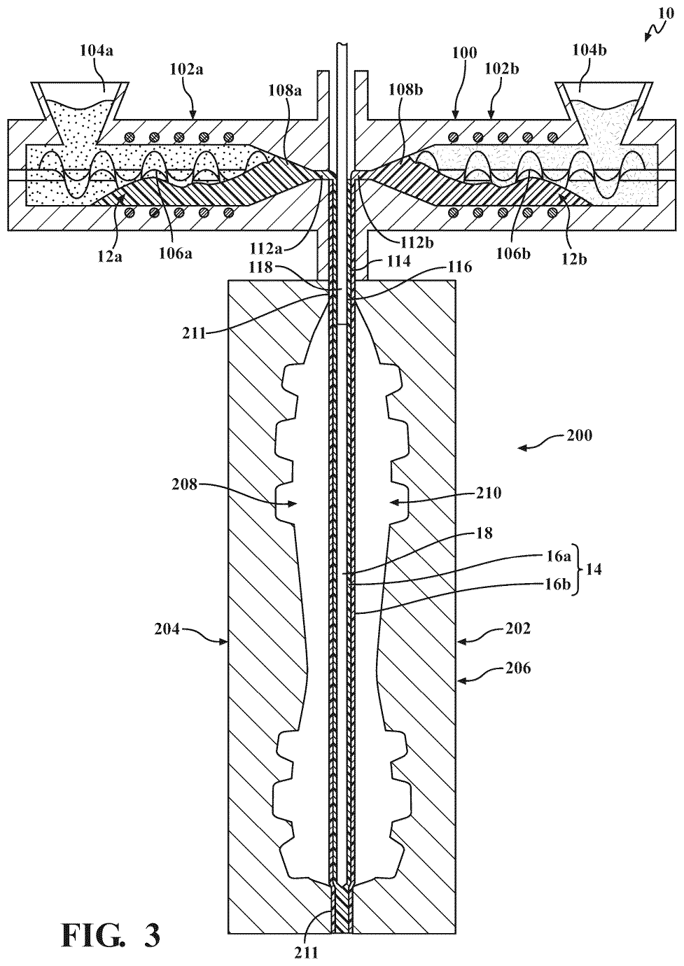

The mold plates 204, 206 are configured to interface with each other in the closed configuration (FIG. 3) to form a peripheral seal 211 around the parison 14. Thus, a peripheral portion of the parison 14 may be compressed between the mold plates 204, 206 when the mold plates 204, 206 are in the closed configuration. As shown, the mold plates 204, 206 are also configured to form a peripheral seal 211 between the blow pin 116 and the parison 14 at an entry to the mold chamber 205 to prevent fluid from escaping the mold chamber 205 during the blow molding process.

Referring to FIG. 2, a first step for forming a molded article 300 according to the present disclosure is shown. In FIG. 2, the mold assembly 202 is initially provided in the open configuration, whereby the mold plates 204, 206 are spaced apart from each other to open the mold chamber 205. The extrusion system 100 extrudes the parison 14 including the one or more layers 16a, 16b of materials 12a, 12b between the mold plates 204, 206 and through the mold chamber 205. As shown, a distal end of the parison 14 extends beyond the mold chamber 205 and is aligned with ends of the mold plates 204, 206.

At FIG. 3, the mold assembly 202 is moved to the closed configuration to form the peripheral seal 211 around the parison 14. As shown, the distal end of the parison 14 is compressed between the mold plates 204, 206 to seal the interior cavity 18 at the distal end of the parison 14. Concurrently, the mold plates 204, 206 interface at a proximal end (i.e., adjacent to the end die 114) of the parison 14 to form the peripheral seal 211 around the parison 14 and the blow pin 116. Thus, at FIG. 3, the parison 14 is sealed at each of the distal end and the proximal end, whereby fluid can be introduced into the interior cavity 18 of the parison 14 via the conduit 118 of the blow pin 116 to expand the parison 14 into the mold plates 204, 206.

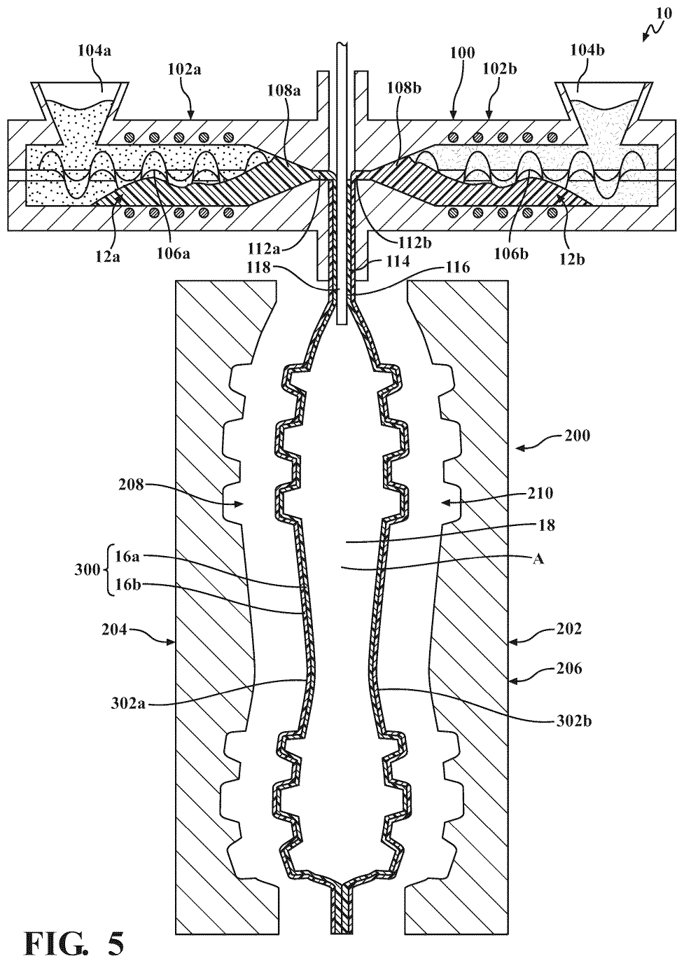

At FIG. 4, compressed air A is introduced into the interior cavity 18 of the parison 14 via the blow pin 116 to bias the layers 16a, 16b of the materials 12a, 12b of the parison 14 outwardly and into the respective mold cavities 208, 210. As shown, the mold cavities 208, 210 of the illustrated example are configured to form a molded article 302 including sole plates 306, 308 having molded traction elements 314. Particularly, the first mold cavity 208 is configured to form a first sole plate 306 including a first sole plate body 310 and a plurality of the traction elements 314. The second mold cavity 210 is configured to form a second sole plate 308 including a second sole plate body 312 and a plurality of the traction elements 314. At FIG. 5, the mold assembly 202 is moved to the open configuration so that the molded article 300 including the sole plates 306, 308 can be cooled and removed from the mold chamber 205.

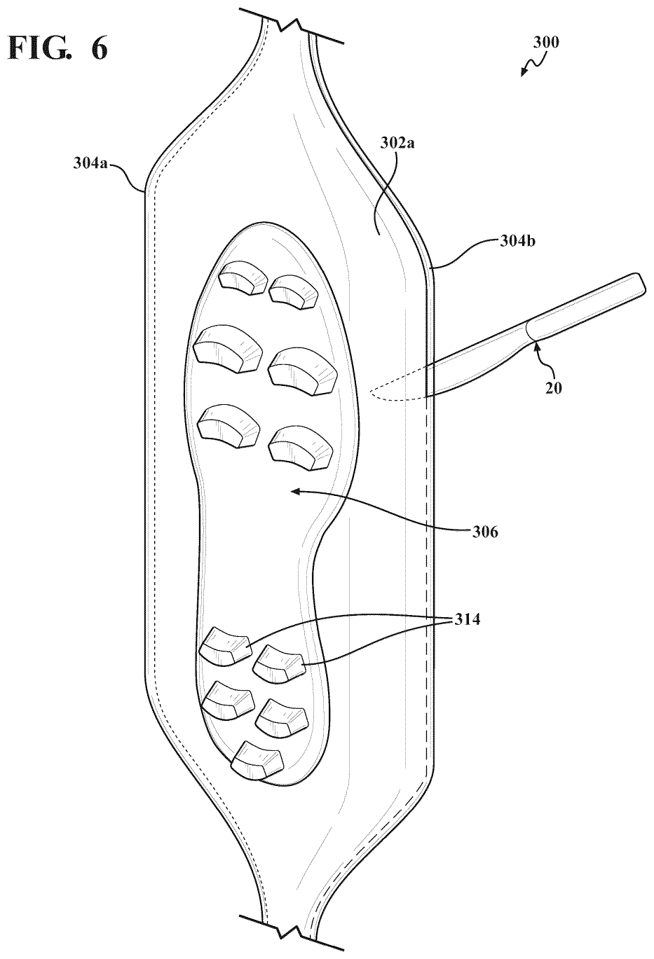

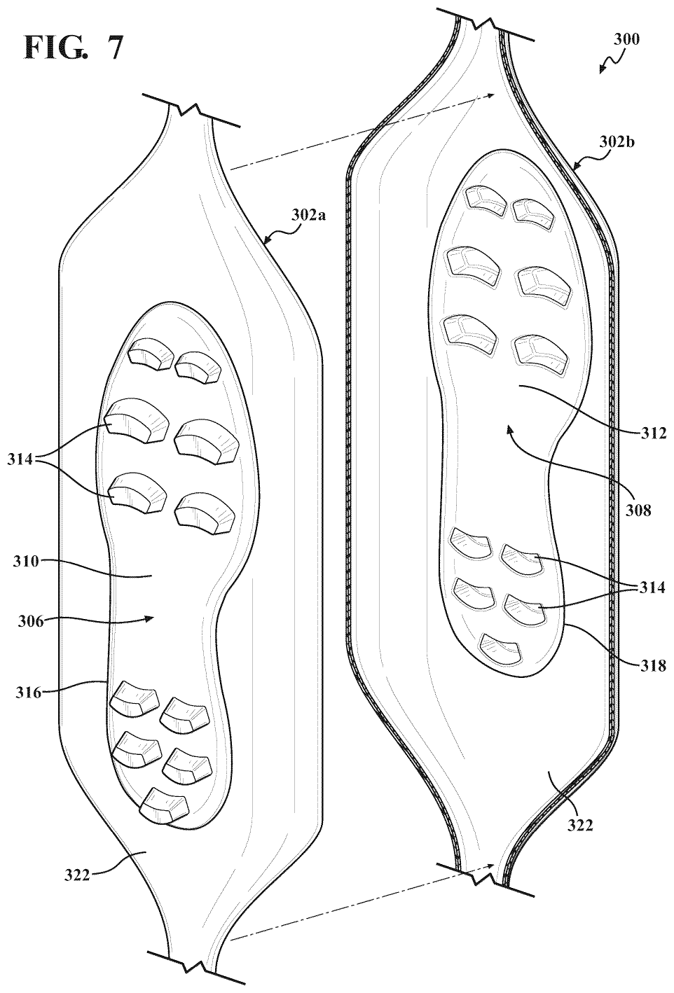

Referring to FIG. 6, the molded article 300 is shown after removal from the mold chamber 205. In this example, the molded article 300 includes a plurality of molded article sections 302a, 302b corresponding to the number of mold plates 204, 206. Thus, the molded article 300 may include a first molded article section 302a and a second molded article section 302b joined to each other at molded article seams 304 corresponding to the joints between the mold plates 204, 206. The first molded article section 302a includes the first sole plate 308 and mold material flashing 322 associated with excess mold material of the parison 14. The second molded article section 302b includes the second sole plate 310 and mold material flashing 322 associated with excess mold material of the parison 14. As shown, the molded article seams 304 are formed within the mold flashing 322 between adjacent ones of the molded article sections 302a, 302b. Optionally, the molded article sections 302a, 302b may be separated from each other along the molded article seams 304 using a cutting tool 20. While the illustrated example shows a manual cutting tool 20 (e.g., a knife), the blow molding system 10 may include automated cutting tools, such as a die cutting device or a computer numerical control (CNC) cutting system. FIG. 7 shows the molded article 300 in a separated state including the first molded article section 302a and the second molded article section 302b.

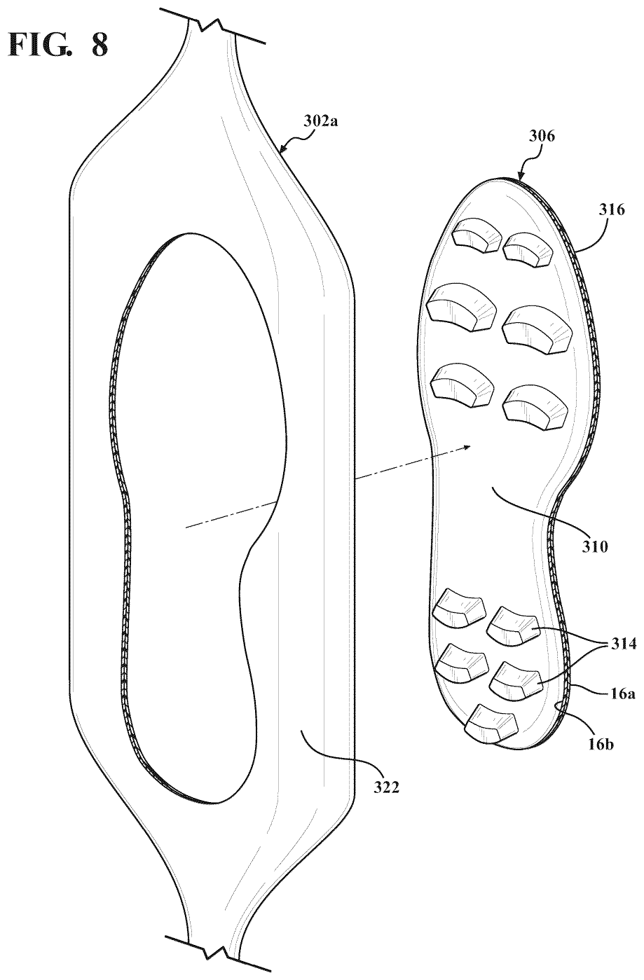

Referring to FIG. 8, the first molded article 302a is shown in isolation for post-mold processing. In this step, the first sole plate 306 is separated from the first molded article section 302a by removing the mold flashing 322 from a first plate body periphery 316. As shown, the first sole plate 306 includes each of the layers 16a, 16b of the parison 14, which cooperate to define the structure of the sole plate 306. The illustrated sole plate 306 includes a first sole plate body 312 and a plurality of traction elements 314, each including the layers 16a, 16b. Again, while the illustrated examples of the sole plates 310, 312 are provided with two layers 16a, 16b, any number of material layers may be incorporated into the sole plates 310, 312 by selecting a corresponding extrusion system 100 for forming a parison 14 with the desired layer configuration. Additionally or alternatively, thicknesses T₁₆, T_{16b} of the layers 16a, 16b may be varied and/or the layers 16a, 16b may be intermittently provided in independent zones of the sole plates 306, 308.

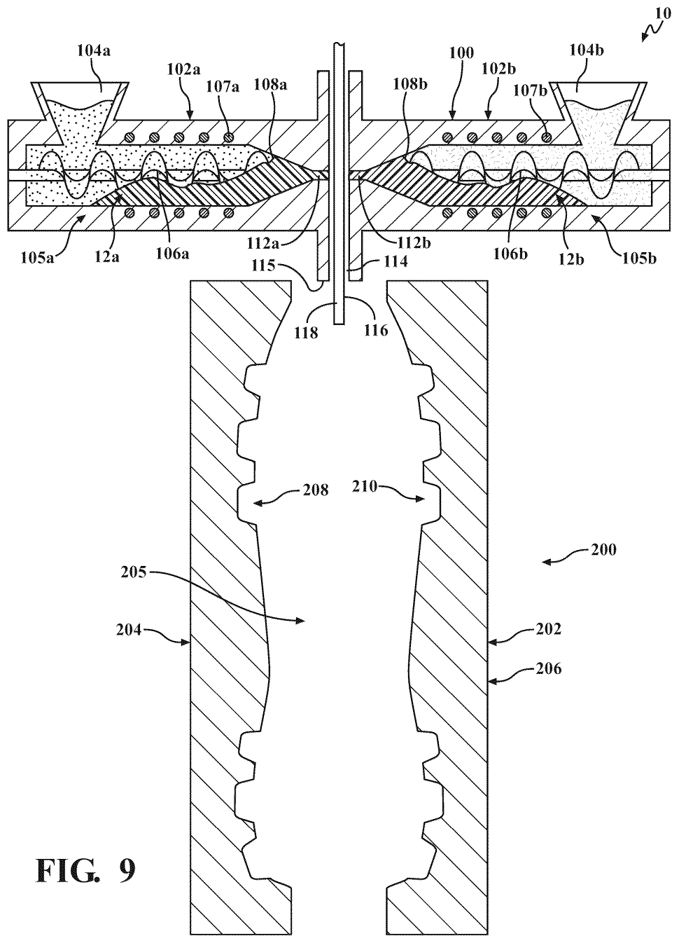

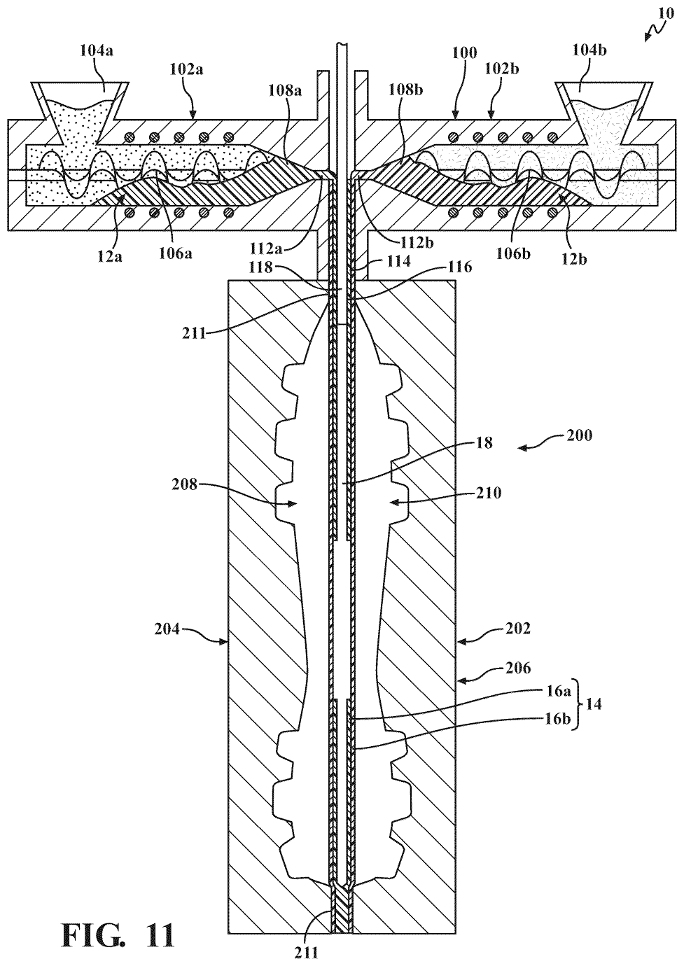

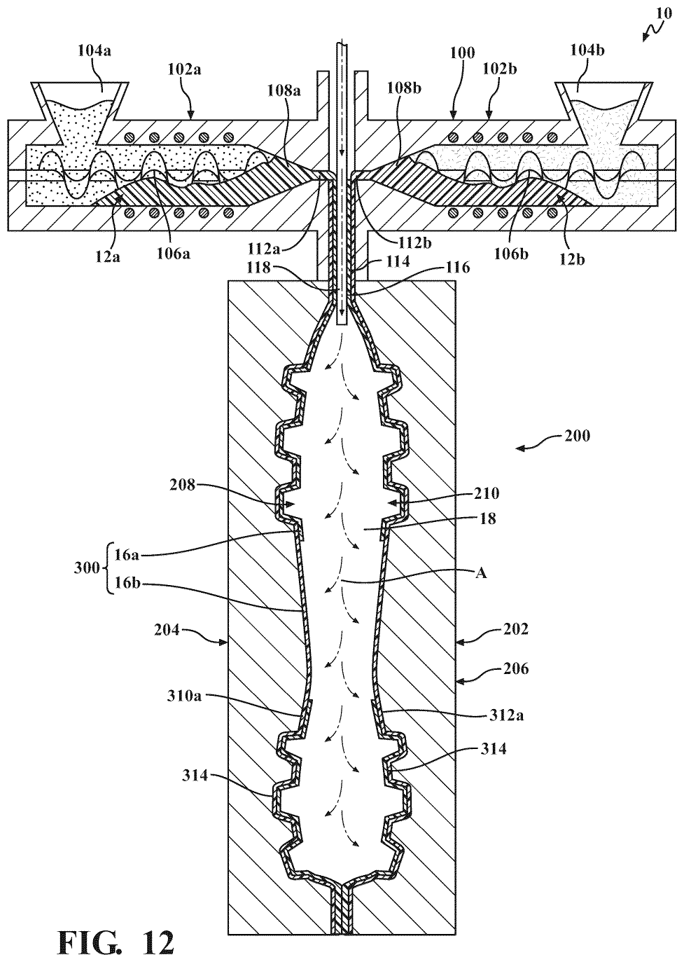

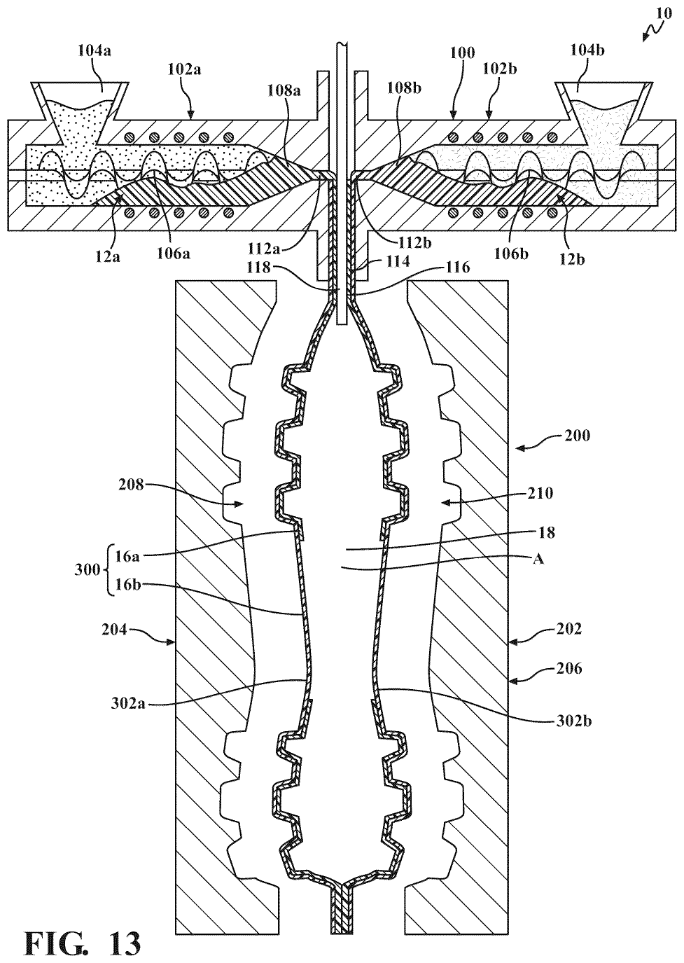

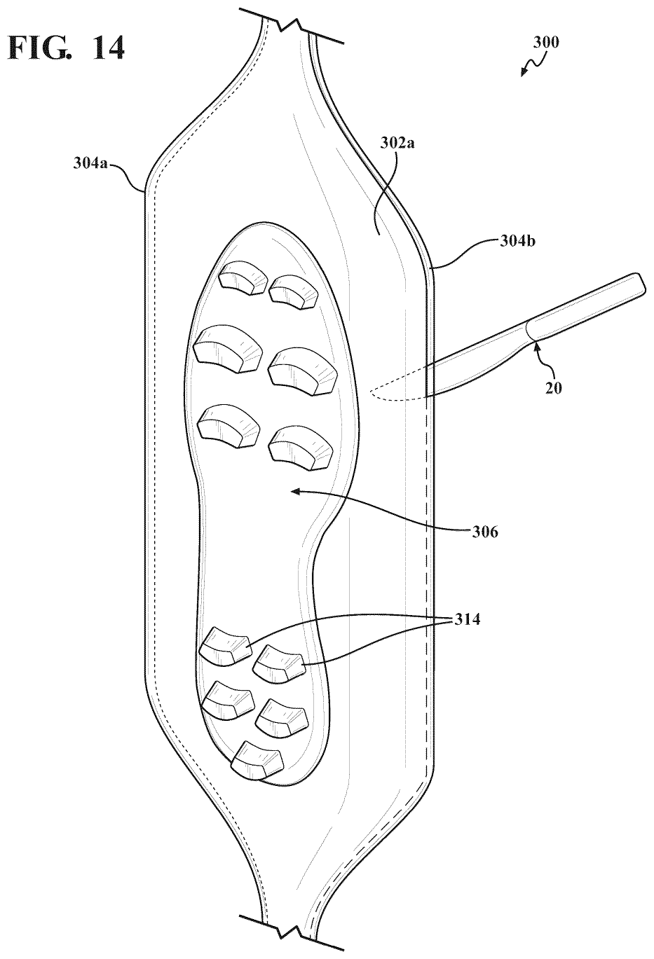

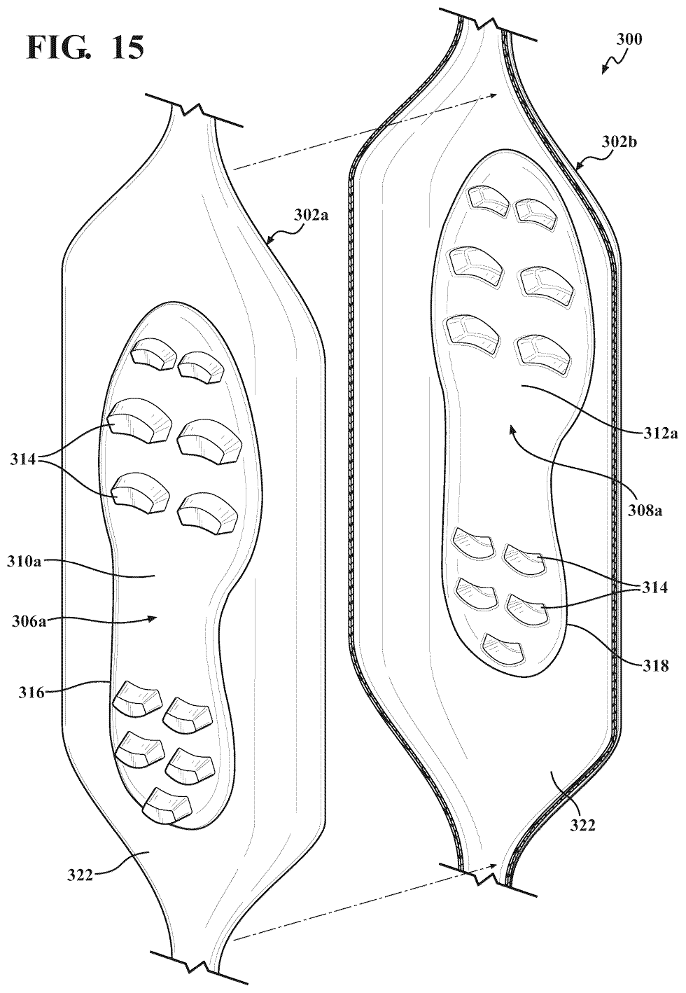

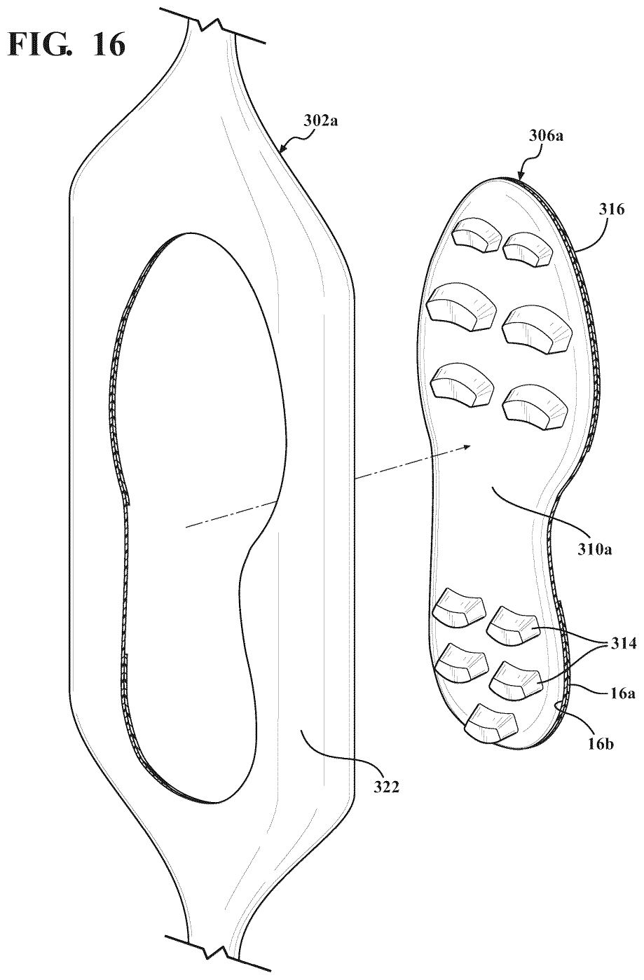

With particular reference to FIGS. 9-16, another example of use of the blow molding system 10 is provided. In view of the substantial similarity in structure and function of the components associated with the blow molding system 10 of FIGS. 1-8 with respect to the blow molding system 10 of FIGS. 9-16, like reference numerals are used hereinafter and in the drawings to identify like components while like reference numerals containing letter extensions are used to identify those components that have been modified.

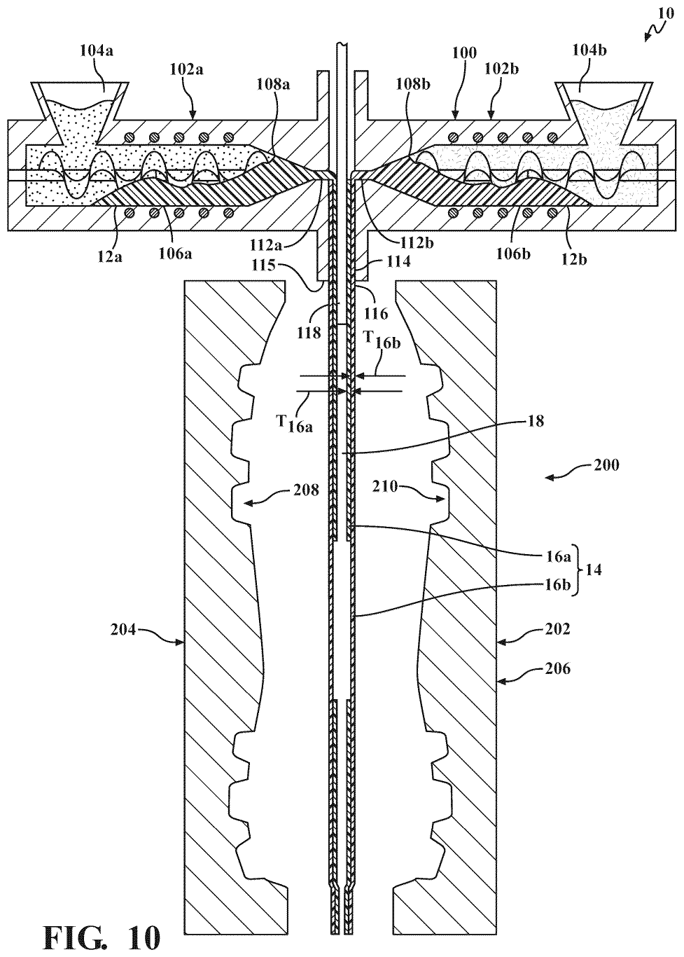

As discussed above, the blow molding system 10 may be configured to intermittently extrude one or more of the layers 16a, 16b to provide variable properties in the sole plates. In the example of FIGS. 9-16, the inner layer 16a of the parison 14a is intermittently extruded to provide an intermediate portion of the parison 14a where the inner layer 16a is omitted. Thus, as shown in FIGS. 10-13 and 16, the parison 14a forms plates 306a, 308a where the inner layer 16a is omitted from a midfoot region of the body 310a, 312a to provide increased flexibility along the midfoot and relatively high stiffness in the forefoot and heel regions associated with the traction elements 314.

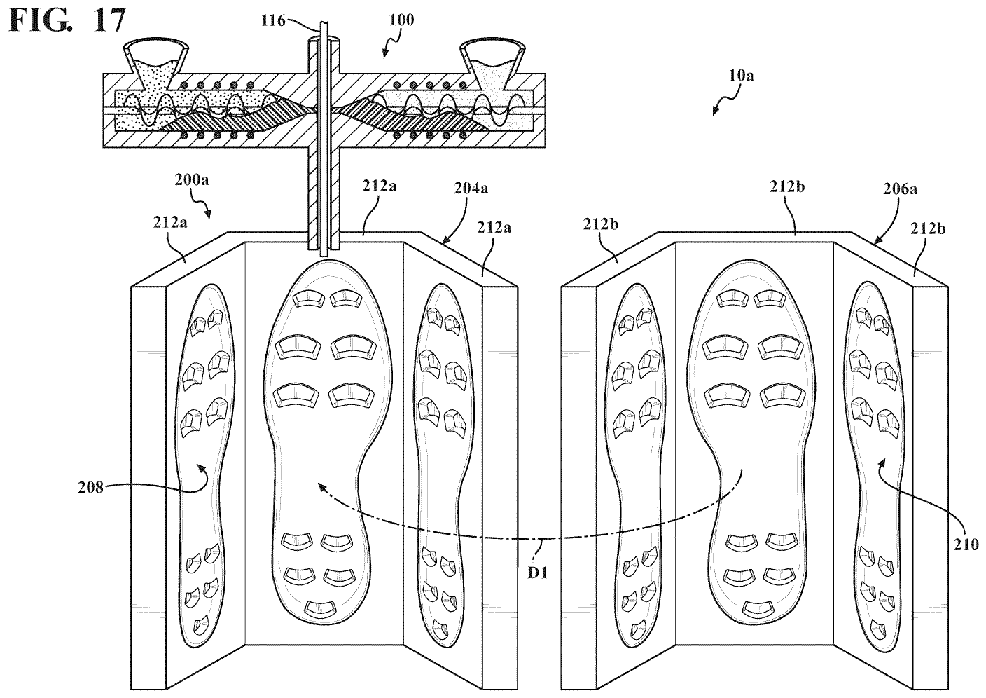

With particular reference to FIGS. 17-20, a blow molding system 10a according to another example of the disclosure is provided. In view of the substantial similarity in structure and function of the components associated with the blow molding system 10 with respect to the blow molding system 10a, like reference numerals are used hereinafter and in the drawings to identify like components while like reference numerals containing letter extensions are used to identify those components that have been modified.

Referring to FIG. 17, the blow molding system 10a includes the extrusion system 100 previously described and a mold system 200a including a mold assembly 202a having a first mold plate 204a and a second mold plate 206a. The first mold plate 204a includes a plurality of first mold segments 212a each defining a single first mold cavity 208. Conversely, the second mold plate 206a includes a plurality of second mold segments 212b each defining a single second mold cavity 210. While the illustrated example shows the first mold segments 212a and the second mold segments 212b respectively integrated into unitary mold plates 204a, 206a, the mold segments 212a, 212b may be provided as independent components. Further, the mold assembly 202a may have any quantity of mold segments 212a, 212b corresponding to a desired number of sole plates 306, 308 to be formed using the blow molding system 10a. For example, the mold plates 204a, 206b may each include two of the mold segments 212a, 212b, three of the mold segments 212a, 212b, four of the mold segments 212a, 212b, or at least five of the mold segments 212a, 212b.

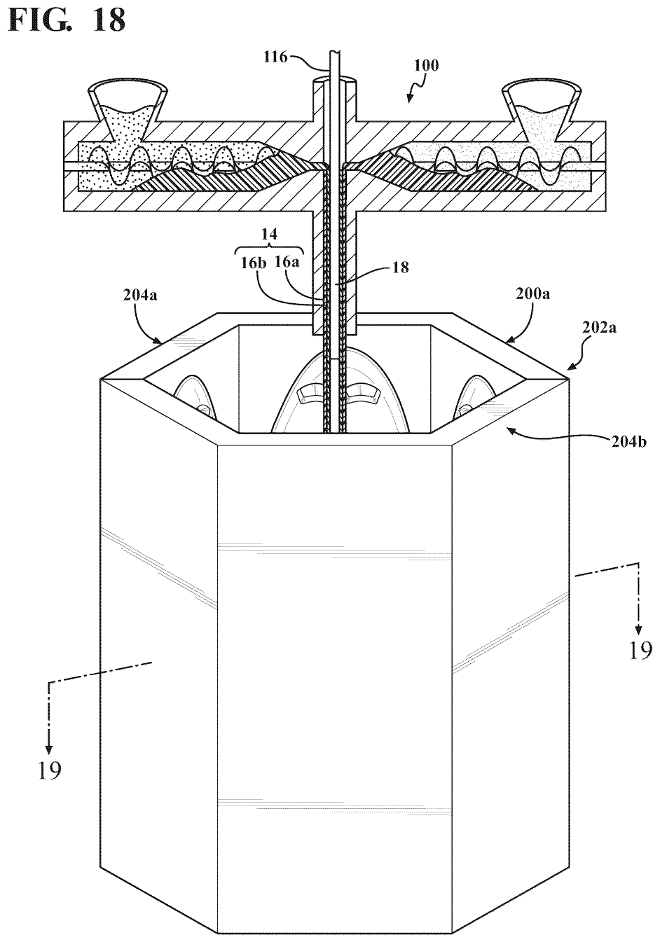

At FIG. 17, the mold assembly 202a is shown in an open configuration for the sake of illustrating the respective mold cavities 208, 210 of each mold plate 204a, 206a. However, it should be appreciated that the mold plates 204a, 206a would be configured to move along direction D1 to interface with each other in the closed configuration (FIG. 18) and to provide a peripheral seal along a distal end of the parison 14 and an opposite proximal end of the parison 14, as described previously with respect to the mold system 200.

At FIG. 18, the mold assembly 202 is moved to the closed configuration to define the mold chamber 205a for receiving the extruded parison 14. Again, the ends of the mold assembly 202 have been omitted for clarity, but it will be understood that the mold assembly 202a is configured to form a seal around the proximal end of the parison 14 and the blow pin 116. As shown, the parison 14 is extruded into the mold chamber 205a between the mold segments 212a, 212b.

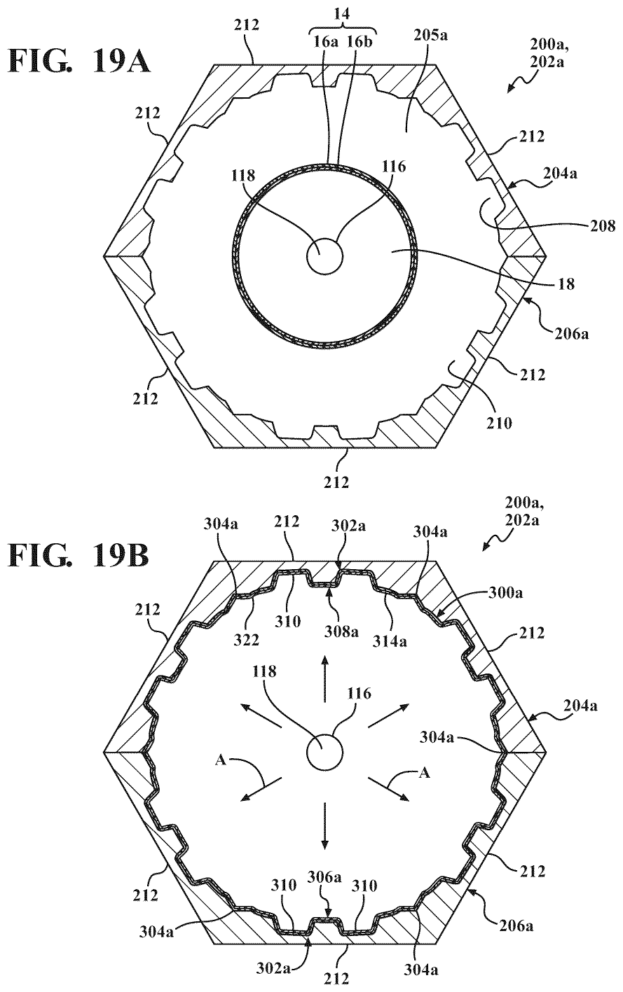

At FIG. 19A, a first cross-sectional view of the blow molding system 10a, taken along Line 19-19 of FIG. 18, shows an intermediate portion of the parison 14 (i.e., between the sealed distal end and proximal end) disposed within the mold chamber 205a, whereby the blow pin 116 is positioned within an interior cavity 18 of the parison 14 while the parison 14 is in an unexpanded state. At FIG. 19B, pressurized air is provided to the interior cavity 18 of the parison 14 via the blow pin 116 and the layers 16a, 16b of the parison 14 are biased outwardly against the mold segments 212a, 212b. The layers 16a, 16b of the parison 14 conform to the mold segments 212a, 212b and, more particularly, to the mold cavities 208, 210. In so doing, the layers 16a, 16b form a molded article 300a including a plurality of molded article sections 302a, 302b having the first sole plates 306 and the second sole plates 308. Particularly, the molded article 300a includes a plurality of the first molded article sections 302a formed by the first mold plate 204a and including a plurality (e.g., three) of the first sole plates 306. The molded article 300a further includes a plurality of the second molded article sections 302b formed by the second mold plate 204b and including a plurality (e.g., three) of the second sole plates 308. Each of the molded article sections 302a, 302b includes the parison flashing 322 and adjacent ones of the molded article sections 302a, 302b are joined together along respective molded article seams 304a, 304b.

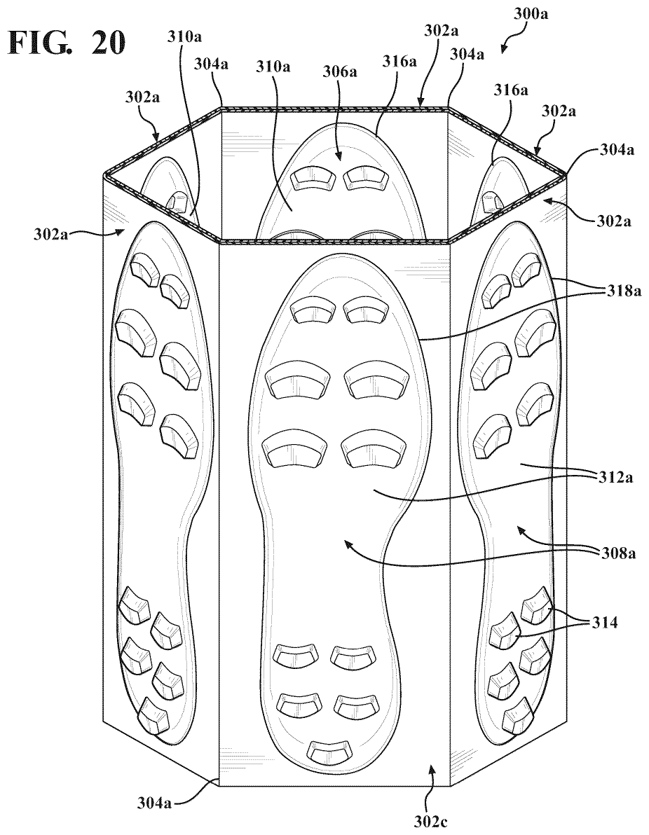

At FIG. 20, the molded article 300a is shown after removal from the mold assembly 202a. As shown, the molded article 300a includes the plurality of the molded article sections 302a, 302b joined together along the molded article seams 304a, 304b. Similar to the molded article 300 discussed above, the molded article sections 302a, 302b may be separated from each other along the molded article seams 304a, 304b for post-processing. In a post-processing step, the first sole plates 306 are separated from the first molded article sections 302a and the second sole plates 308 are separated from the second molded article sections 302b by removing the flashing 322 from the respective peripheries 316, 318 of the sole plate bodies 310, 312.

In the illustrated example, the mold system 200 is configured to form a plurality of full-length sole plates 306, 308 including a forefoot region, a midfoot region, and a heel region. However, the mold assembly 200 may be configured to form other plate components of an article of footwear, such as partial-length plates. As used herein, the term “plate” refers to a rigid or semi-rigid component for use in an article of footwear. For example, the plate components formed using the methods and systems of the present disclosure may have a stiffness (i.e., Young's Modulus) of at least 10 gigapascals.

In the illustrated example, the parison 14 is extruded with a continuous inner layer 16a including a first thickness T₁₆ₐ and a continuous outer layer 16b having a second thickness T_{16b}. While the representative example shows the first thickness T₁₆ₐ being the same as the second thickness T_{16b}, the thickness T₁₆ₐ, T_{16b} of any one of the layers 16a, 16b may be different than the thickness T₁₆ₐ, T_{16b} of any of the other layers to impart desired mechanical properties to the finished sole plate 306, 308. Additionally or alternatively, one or more of the layers 16a, 16b may be intermittently extruded to provide independent zones that exclude one of the layers 16a, 16b. For example, the outer layer 16b may be extruded in regions of the parison 14 corresponding to a forefoot region and a heel region of the sole plate 306, 308 to provide an increased stiffness in areas associated with traction elements 314, while the outer layer 16b may be omitted (i.e., not extruded) in a region of the parison associated with a midfoot region of the sole plate 306, 308 to provide a reduced stiffness.

The following Clauses provide an exemplary configuration for a method of forming a fluid-filled chamber for an article of footwear described above.

Clause 1: A blow molding system including an extrusion system including at least one extruder configured to extrude a parison having an interior cavity, a blow pin configured to extend into the interior cavity of the parison extruded from the extrusion system, a mold assembly defining a mold chamber configured to receive the parison, the mold assembly including a plurality of mold cavities each facing the mold chamber and defining a profile of a sole component of an article of footwear.

Clause 2: The blow molding system of Clause 1, wherein the at least one extruder includes a first extruder configured to extrude a first layer of the parison and a second extruder configured to extrude a second layer of the parison concentric with the first layer.

Clause 3: The blow molding system of Clause 2, wherein the first layer comprises a first material and the second layer comprises a second material different than the first material.

Clause 4: The blow molding system of Clause 3, wherein the first material and the second material are selected from at least one of a polypropylene, a high-density polyethylene, a thermoplastic polyurethane, or a polyamide.

Clause 5: The blow molding system of Clause 3, wherein at least one of the first material and the second material comprises a recycled material.

Clause 6: The blow molding system of Clause 1, wherein the plurality of mold cavities includes a first mold cavity defining a profile of a first sole plate of an article of footwear and a second mold cavity defining a profile of a second sole plate of the article of footwear having a different configuration than the first sole plate.

Clause 7: The blow molding system of Clause 1, wherein the plurality of mold cavities includes a first plurality of first mold cavities each defining a profile of a first sole plate of an article of footwear and a second plurality of second mold cavities each defining a profile of a second sole plate of the article of footwear having a different configuration than the first sole plate.

Clause 8: The blow molding system of Clause 1, wherein each of the plurality of the mold cavities defines a profile for a sole plate including a full-length sole plate body and a plurality of traction elements.

Clause 9: A sole plate for an article of footwear formed using the blow molding system of any one of Clauses 1-8.

Clause 10: An article of footwear including a sole plate of Clause 9.

Clause 11: A method of forming a plurality of sole plates for an article of footwear, the method including extruding a parison into a mold chamber of a mold assembly, the mold assembly including a plurality of mold cavities each facing the mold chamber and defining a profile of the sole plate of an article of footwear, and expanding the parison in the mold chamber, a material forming the parison conforming to the plurality of the mold cavities and forming a molded article including the plurality of the sole plates.

Clause 12: The method of Clause 11, wherein extruding the parison includes extruding a first layer of the parison and a second layer of the parison concentric with the first layer.

Clause 13: The method of Clause 12, wherein extruding the first layer of the parison and the second layer of the parison includes continuously extruding the first layer and intermittently extruding the second layer along a length of the parison.

Clause 14: The method of Clause 12, wherein the first layer comprises a first material and the second layer comprises a second material different than the first material.

Clause 15: The method of Clause 14, wherein the first material and the second material are selected from at least one of a polypropylene, a high-density polyethylene, a thermoplastic polyurethane, or a polyamide.

Clause 16: The method of Clause 14, wherein at least one of the first material and the second material comprises a recycled material.

Clause 17: The method of Clause 11, wherein the plurality of mold cavities includes a first mold cavity defining a profile of a first sole plate of an article of footwear and a second mold cavity defining a profile of a second sole plate of the article of footwear having a different configuration than the first sole plate.

Clause 18: The method of Clause 11, wherein the plurality of mold cavities includes a first plurality of first mold cavities each defining a profile of a first sole plate of an article of footwear and a second plurality of second mold cavities each defining a profile of a second sole plate of the article of footwear having a different configuration than the first sole plate.

Clause 19: The method of Clause 11, wherein each of the mold cavities defines a profile for a sole plate including a full-length sole plate body and a plurality of traction elements.

Clause 20: The method of Clause 11, further comprising separating the plurality of the sole plates from the molded article.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A blow molding system comprising:
an extrusion system including at least one extruder configured to extrude a parison having an interior cavity;
a blow pin configured to extend into the interior cavity of the parison extruded from the extrusion system; and
a mold assembly defining a mold chamber configured to receive the parison, the mold assembly including a plurality of mold cavities each facing the mold chamber and defining a profile of a sole component of an article of footwear.

2. The blow molding system of claim 1, wherein the at least one extruder includes a first extruder configured to extrude a first layer of the parison and a second extruder configured to extrude a second layer of the parison concentric with the first layer.

3. The blow molding system of claim 2, wherein the first layer comprises a first material and the second layer comprises a second material different than the first material.

4. The blow molding system of claim 3, wherein the first material and the second material are selected from at least one of a polypropylene, a high-density polyethylene, a thermoplastic polyurethane, or a polyamide.

5. The blow molding system of claim 3, wherein at least one of the first material and the second material comprises a recycled material.

6. The blow molding system of claim 1, wherein the plurality of mold cavities includes a first mold cavity defining a profile of a first sole plate of an article of footwear and a second mold cavity defining a profile of a second sole plate of the article of footwear having a different configuration than the first sole plate.

7. The blow molding system of claim 1, wherein the plurality of mold cavities includes a first plurality of first mold cavities each defining a profile of a first sole plate of an article of footwear and a second plurality of second mold cavities each defining a profile of a second sole plate of the article of footwear having a different configuration than the first sole plate.

8. The blow molding system of claim 1, wherein each of the plurality of the mold cavities defines a profile for a sole plate including a full-length sole plate body and a plurality of traction elements.

9. A sole plate for an article of footwear formed using the blow molding system of claim 1.

10. An article of footwear including a sole plate of claim 9.

11. A method of forming a plurality of sole plates for an article of footwear, the method comprising:
extruding a parison into a mold chamber of a mold assembly, the mold assembly including a plurality of mold cavities each facing the mold chamber and defining a profile of the sole plate of an article of footwear; and
expanding the parison in the mold chamber, a material forming the parison conforming to the plurality of the mold cavities and forming a molded article including the plurality of the sole plates.

12. The method of claim 11, wherein extruding the parison includes extruding a first layer of the parison and a second layer of the parison concentric with the first layer.

13. The method of claim 12, wherein extruding the first layer of the parison and the second layer of the parison includes continuously extruding the first layer and intermittently extruding the second layer along a length of the parison.

14. The method of claim 12, wherein the first layer comprises a first material and the second layer comprises a second material different than the first material.

15. The method of claim 14, wherein the first material and the second material are selected from at least one of a polypropylene, a high-density polyethylene, a thermoplastic polyurethane, or a polyamide.

16. The method of claim 14, wherein at least one of the first material and the second material comprises a recycled material.

17. The method of claim 11, wherein the plurality of mold cavities includes a first mold cavity defining a profile of a first sole plate of an article of footwear and a second mold cavity defining a profile of a second sole plate of the article of footwear having a different configuration than the first sole plate.

18. The method of claim 11, wherein the plurality of mold cavities includes a first plurality of first mold cavities each defining a profile of a first sole plate of an article of footwear and a second plurality of second mold cavities each defining a profile of a second sole plate of the article of footwear having a different configuration than the first sole plate.

19. The method of claim 11, wherein each of the mold cavities defines a profile for a sole plate including a full-length sole plate body and a plurality of traction elements.

20. The method of claim 11, further comprising separating the plurality of the sole plates from the molded article.
